(19) United States
(12) Patent Application Publication
(10) Pub. No.: US 2021/0295626 A1
(43) Pub. Date: Sep. 23, 2021

(54) AUTOMATIC PAYMENT MACHINE AND AUTOMATIC PAYMENT MACHINE CONTROL METHOD

(71) Applicant: FUJITSU FRONTECH LIMITED, Tokyo (JP)

(72) Inventors: Hisana YAMAGUCHI, Inagi (JP); Mitsuo WATANABE, Inagi (JP)

(73) Assignee: FUJITSU FRONTECH LIMITED, Tokyo (JP)

(21) Appl. No.: 17/340,175

(22) Filed: Jun. 7, 2021

Related U.S. Application Data
(63) Continuation of application No. PCT/JP2019/002919, filed on Jan. 29, 2019.

(51) Int. Cl. G07C 9/00; G07C 9/22; G06K 9/00

(52) U.S. Cl. CPC G07C 9/00904; G07C 9/22; G07C 2009/00976; G06K 9/00463; G06K 2209/01; G06K 9/00456

(57) ABSTRACT

An automatic payment machine includes an information reading section, an image reading section, a display acceptance section, a key issuing section, and a control section. The control section instructs the information reading section to read passport information. Upon acquiring the passport information via the information reading section, the control section verifies reservation information and instructs the key issuing section to issue a room key, based on the verification result. Upon failing to acquire the passport information via the information reading section, the control section instructs the display acceptance section to display a designation screen for performing an operation to acquire image data of a passport, acquires the image data, instructs the image reading section to perform character recognition on the image data and read character information, verifies the reservation information, and instructs the key issuing section to issue the room key, based on the verification result.

### CROSS-REFERENCE TO RELATED APPLICATION

This application is a continuation application of International Application PCT/JP2019/002919 filed on Jan. 29, 2019 which designated the U.S., the entire contents of which are incorporated herein by reference.

### FIELD

The embodiments discussed herein relate to an automatic payment machine and an automatic payment machine control method.

### BACKGROUND

In recent years machines which accept operation by a customer to provide an article, a service, or the like on a self-service basis have spread in various facilities. Room key issuing systems used in hotels, automatic fare adjustment machines installed in stations, automatic drink vending machines and the like are known as such machines.

For example, a technique for reading: a passport, performing an OCR process on image information on the passport for character recognition, making an inquiry about reservation information on the basis of a result of the character recognition, and issuing a room key on the basis of the reservation information is known as a room key issuing system.

See, for example, Japanese Laid-open Patent Publication

The conventional technique is for reading a passport, performing character recognition, making an inquiry about reservation information, and issuing a room key. However, a detailed measure is not considered for the function of reading a passport.

There is need in lodging facilities, such as hotels, to check a passport of an alien customer. In some cases, however, an alien customer is unaccustomed to the operation of a machine and has difficulty in the operation of reading a passport. Furthermore, even if machines which read a passport are installed in lodging facilities, there is need for attendants to help alien customers who are unaccustomed to the operation of the machines. As a result, though the machines are introduced to solve the shortage of hands, there are cases where time taken for attendants to help alien customers or their efforts are not reduced.

Accordingly, it is hoped that a passport reading function which automatic payment machines used in lodging facilities have will be improved.

### SUMMARY

According to an aspect of the embodiments, there is provided an automatic payment machine including: a passport information reader which reads passport information stored in a memory included in a passport; an image reader which acquires image data, which performs a character recognition on the image data, and which reads character information; a display panel which displays a screen and which accepts an input; a key issuing interface which issues a room key; and a processor which gives the passport information reader instructions to read the passport information and performs a process including first verifying, upon acquiring the passport information via the passport information reader, reservation information and giving the key issuing interface, based on a result of the first verification, instructions to issue the room key; and giving, upon failing to acquire the passport information via the passport information reader, the display panel instructions to display a designation screen for performing an operation to acquire the image data of the passport, acquiring the image data of the passport, giving the image reader instructions to perform the character recognition on the image data and read the character information, second verifying the reservation information after reading the character information, and giving the key issuing interface, based on a result of the second verification, instructions to issue the room key.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWING

FIG. 1 illustrates an example of an automatic payment machine according to a first embodiment

FIG. 2 illustrates an example of an information processing system according to a second embodiment;

FIG. 3 illustrates an example of a hardware configuration of a lodging management server in the second embodiment;

FIG. 4 illustrates an example of a hardware configuration of an automatic payment machine in the second embodiment;

FIGS. 5A and 5B illustrate an example of a passport image and a passport reading area in the second embodiment;

FIGS. 6A and 6B illustrate an example of variations of the reading area in the second embodiment (part 1);

FIGS. 7A and 7B illustrate an example of variations of the reading area in the second embodiment (part 2);

FIGS. 8A to 8C illustrate an example of detecting an OCR region of a passport in the second embodiment;

FIGS. 9A and 9B illustrate an example of a sensor of a scanner section in the second embodiment;

FIGS. 10A and 10B illustrate an example of detecting a passport by a sensor in the second embodiment;

FIGS. 11A to 11C illustrate an example of a display screen on the automatic payment machine in the second embodiment;

FIG. 12 illustrates an example of a flow chart illustrative of a process by the automatic payment machine in the second embodiment (part 1);

FIG. 13 illustrates an example of a flow chart illustrative of a process by the automatic payment machine in the second embodiment (part 2);

FIG. 14 illustrates an example of a flow chart illustrative of a process by the automatic payment machine in the second embodiment (part 3);

FIG. 15 illustrates an example of a flow chart illustrative of a first scanner reading process in the second embodiment; and

FIG. 16 illustrates an example of a flow chart illustrative of a second scanner reading process in the second embodiment.

### DESCRIPTION OF EMBODIMENTS

Embodiments will now be described in detail by referring to the drawings.

### First Embodiment

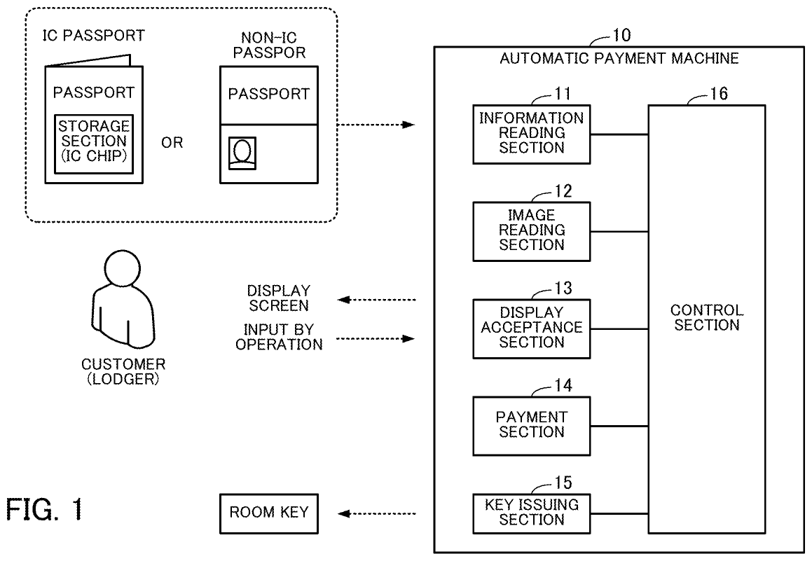

First an automatic payment machine according to a first embodiment will be described by the use of FIG. 1. FIG. 1 illustrates an example of an automatic payment machine according to a first embodiment.

An automatic payment machine 10 is used by a lodger (hereinafter stated as a customer) who uses a lodging facility, such as a hotel, for performing a lodging procedure (check-in). The automatic payment machine 10 may be installed not only in lodging facilities, such as hotels, but also in various facilities, such as airport lobbies, station and port waiting rooms, commercial buildings, office buildings, and theme parks. The customer who uses the automatic payment machine 10 is a foreign national. Accordingly, when the customer uses a lodging facility, there is need to check a passport.

The automatic payment machine 10 performs information communication with an information processing apparatus which manages reservation information regarding a lodging facility. The automatic payment machine 10 requests the information processing apparatus to make an inquiry about reservation information for the customer who uses the lodging facility, and acquires the reservation information. The reservation information includes a reservation number of the customer, a lodging date, payment, information (information indicative of whether or not hotel charges have been paid), a room number, a room type, and the like. Passport information (passport number, a nationality, a name, and the date of birth) read from the passport may be used in place of the reservation number. Furthermore, the automatic payment machine 10 performs information communication with an information processing apparatus which makes card payment. The automatic payment machine 10 communicates with the information processing apparatus via a network and performs a payment process by the use of a card Each information processing apparatus is not illustrated.

The automatic payment machine 10 includes an information reading section 11, an image reading section 12, a display acceptance section 13, a payment section 14, a key issuing section 15, a control section 16, and the like.

The information reading section 11 has the function of reading passport information stored in a storage section (for example, an IC chip) included in the passport, biological information, and the like. For example, the information reading section 11 is an IC reader. The information reading section 11 informs the control section 16 of information it reads. The passport information is information (passport number, a nationality, a name, and the date of birth, and the like) contained in a page of the passport on which a photograph appears. In addition, face image data are needed as the biological information. The biological information may include fingerprint image data or iris image data.

The image reading section 12 has the function of reading a passport image. For example, the image reading section is a scanner. The image reading section 12 also has a character recognition function. On the basis of image data read from the passport, the image reading section 12 performs character recognition on a machine readable zone (MRZ) contained in the page of the passport on which the photograph appears and acquires character information (passport number, the nationality, the name, the date of birth, and the like) which consists of 2 lines of 44 characters each and which is contained in the machine readable zone. The character information read from the passport may be used in place of a reservation number.

Furthermore, the image reading section 12 also has the function of reading a bar code printed on a lodging reservation slip or displayed on, for example, the customer's smartphone and acquiring the reservation number from the read bar code. The bar code may be a two-dimensional bar code.

The display acceptance section 13 displays various pieces of Information and accepts instructions inputted by the customer. For example, the display acceptance section 13 is a display and a touch panel fixed on an outer surface of the automatic payment machine 10. The display acceptance section 13 displays a screen for explaining a method for operating the automatic payment machine 10, reservation information regarding the customer, and the like.

The payment section 14 has the function of paying hotel charges. For example, the payment section 14 includes a card acceptance unit and a cash acceptance unit. The card acceptance unit accepts a card (credit card or the like) from the customer who uses the automatic payment machine 10, reads information recorded on the card, communicates with an information processing apparatus, and performs a payment process. The cash acceptance unit has the function of accepting cash (banknote and a coin) paid by the customer and electing change. If the customer pays hotel charges in advance, then a payment process is omitted.

The key issuing section 15 has the function of accepting instructions from the control section 16 to issue a room key and issuing the room key. The room key is a card key used for opening and shutting an electronic lock on a door of a room in which the customer lodges.

The control section. 16 controls the whole of the automatic payment machine 10 and is, for example, a processor.

The control section 16 executes a program which realizes an automatic payment machine control method stored in s storage section and controls the automatic payment machine 10. Furthermore, the control section 16 accepts an input by operation via the display acceptance section 13 and controls the automatic payment machine 10 on the basis of input information which the control section 16 accepts.

The automatic payment machine 10 also includes the storage section (not illustrated) such as a hard disk drive (HDD) and various memories. In addition, the automatic payment machine 10 also includes a receipt section (not illustrated) which prints, for example, the amount of money paid on a receipt and which ejects the receipt.

A method by which the customer checks into the lodging facility by the use of the automatic payment machine 10 will now be described. It is assumed that the customer pays hotel charges in advance and that a payment process is omitted.

The customer bears an IC passport (passport including a storage section), puts the passport over the information reading section 11, and performs operation to make it read passport information. The control section 16 gives the information reading section 11 to read the passport information. If the control section 15 acquires the passport information via the information reading section 11, then the control section 16 verifies reservation information and gives the key issuing section 15 instructions on the basis of a verification result to issue a room key.

If the customer bears a non-IC passport (passport not including a storage section), then the information reading section 11 does not acquire passport information. Furthermore, if the customer who bears an IC passport is unaccustomed to handling and does not put the passport over the information reading section 11, then the information reading section 11 does not acquire passport information.

If the control section 16 does not acquire passport information via the information reading section 11 (if the information is not read out from the storage section included in the passport), then the control section 15 gives the display acceptance section 13 instructions to display a designation screen for performing operation to acquire image data of the passport. The display acceptance section 13 displays a designation screen. For example, the designation screen displays “Find a page of the passport on which a photograph appears and lay the passport face down on the image reading section to make the image reading section read information”.

The control section 15 acquires the image data of the passport, performs character recognition on the image data, and gives the image reading section 12 instructions to read character information. After the character information is read, the control section 16 verifies the reservation information and gives the key issuing section 15 instructions on the basis of a verification result to issue a room key. The customer receives the room key issued by the automatic payment machine 10 and ends a check-in process.

The automatic payment machine 10 acquires from a passport in this way information (passport information or character information and image information of a page of the passport on which a photograph appears) needed at the time of using a lodging facility regardless of whether the passport is an IC passport or a non-IC passport. As has been described, the automatic payment machine 10 improves a passport reading function.

### Second Embodiment

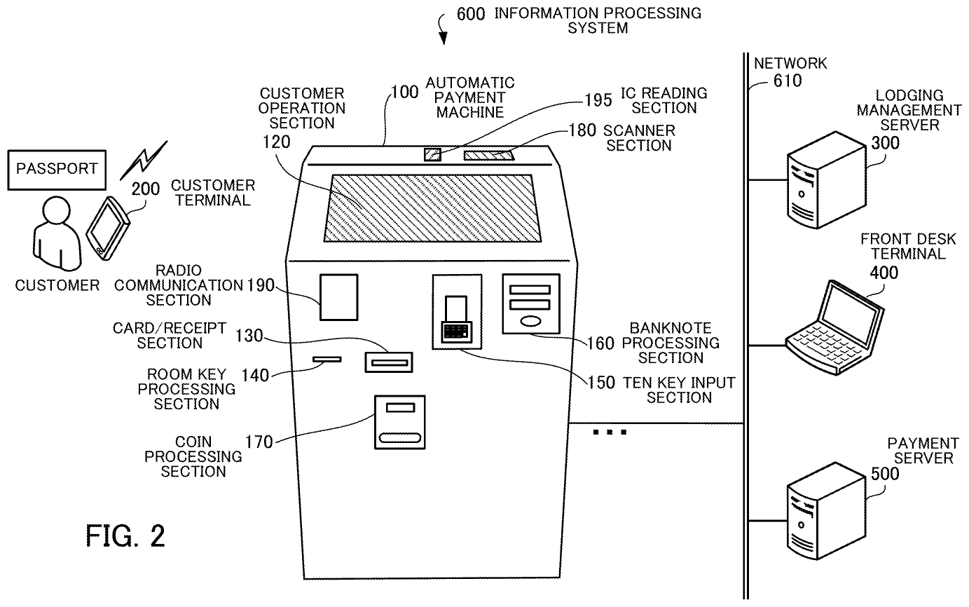

An information processing system to which the automatic payment machine 10 is applied will now be described as a second embodiment by the use of FIG. 2. FIG. 2 illustrates an example of an information processing system according to a second embodiment.

An information processing system 600 realizes a system by which a customer who uses a lodging facility, such as a hotel, performs a check-in procedure. It is assumed that the customer is a traveler from a foreign country and that the customer needs to present a passport at the time of using a lodging facility.

The information processing system 600 includes one or more automatic payment machines 100 (one of them is illustrated in FIG. 2.) and various computers.

The automatic payment machine 100 is connected to a lodging management server 300 via a network 10. The lodging management server 300 performs information communication with a front desk terminal 400 and a payment server 500 via the network 610.

The automatic payment machine 100 has the function of accepting a check-in from the customer via a speech input or an input device, displaying a multilingual screen, paving hotel charges, and issuing a room key. The automatic payment machine 100 has the function of receiving money paid in cash or by other methods.

The automatic payment machine 100 includes a customer operation section. 120, a card/receipt section 130, a room key processing section 140, a ten key input section 150, a banknote processing section 160, a coin processing section 170, a scanner section 180, a radio communication section 190, and an IC reading section 195.

The customer operation section 120 has a display and a touch panel, gives guidance to the customer as to operation, and accepts instructions.

When payment is made by the use of a card such as a point card or a credit card, the card/receipt section 130 reads information of the inserted card. Furthermore, when payment ends, the card/receipt section 130 prints and ejects a receipt.

The ten key input section 150 has buttons for inputting figures and the like and accepts instructions from the customer (user) in conjunction with the touch panel of the customer operation section 120. For example, the ten key input section 150 accepts an input such as a personal identification number for authenticating the card or the like, a selection from choices displayed on the customer operation section 120, or the like. When money is received or paid, the banknote processing section 160 receives or pays a banknote. The banknote processing section 160 has a short-range camera (not illustrated) which photographs the inlet or outlet of a banknote and its vicinity. Accordingly, it is possible to videotape a state in which a banknote is received or paid. When money is received or paid, the coin processing section 170 receives or pays a coin.

The scanner section 180 has the function of a scanner and acquires image information by scanning the whole of the passport laid face down. Furthermore, the scanner section 180 has the function of character recognition. The scanner section 180 performs character recognition on an OCR region (internationally standardized machine readable zone (which is also referred to as an MRZ) including character information which consists of two lines of 44 characters each) of the passport and acquires a passport number, a nationality, a name, the date of birth, and the like as text data. Furthermore, the scanner section 180 has the function of reading a bar code (which may be a two-dimensional bar code). The scanner section 180 has the function of reading a bar code displayed on a reservation slip or a customer terminal 200 and reading a reservation number for identifying reservation information in the lodging facility.

The radio communication section 190 has a communication function. For example, the radio communication section 190 has the function of contactless radio communication such as near field communication (NFC). The automatic payment machine 100 communicates with the customer terminal 200 or the like via the radio communication section 190.

The IC reading section 195 has the function of reading data recorded in an IC chip included in an IC passport or an IC card. The IC reading section 195 reads recorded data by the use of a near field communication technique. The IC reading section 195 performs information communication on the basis of contents standardized in accordance with the RFID standard (ISO/IEC14443), the IC card standard (ISO/IEC7816), the IC passport standard (ICAO Doc9393), and the like. IC passport specifications are laid down by International Civil Aviation Organization (ICAO). A nationality, a passport number, a name, the date of birth, and image data of biological information are recorded in a record section (IC chip or an IC card) included in a passport. The fundamental of the biological information is a face photograph. A fingerprint image or an iris image may be added. Hereinafter a record section (IC chip or an IC card) included in an IC passport will be stated as an IC chip.

The automatic payment machine 100 has the function of inputting and outputting speech and has the function of, for example, a speaker and a microphone (not illustrated).

The customer terminal 200 is a computer used by a user and is a smartphone, a tablet computer, or the like. The customer terminal 200 has the function of executing an application program (hereinafter stated as an application) used for making a payment by the use of the automatic payment machine 100. The customer terminal 200 has the function of performing information communication with various pieces of apparatus.

The lodging management server 300 is computer which transmits information to receives information from the automatic payment machine 100, on which a payment process and a customer authentication process using the automatic payment machine 100 are performed, and on which a program having the function of managing the automatic payment machine 100 is executed. Furthermore, the lodging management server 300 receives various pieces of information from the automatic payment machine 100 and stores them in a storage section of a database, a disk, or the like. The database (not illustrated) is a storage unit which stores various pieces of information and is accessed by the lodging management server 300. In addition, the lodging management server 300 has the function of transmitting to the front desk terminal 400 a situation where the automatic payment machine 100 is used or a situation where instructions to call an attendant are given and the function of transmitting to the payment server 500 instructions to perform a transfer processing.

The front desk terminal 400 is a computer used by an attendant at a front desk of the lodging facility and haying the function of performing information communication with the lodging management server 300. The payment server 500 is a computer having the function of performing a payment process accepted via the automatic payment machine 100. The payment server 500 may be replaced with a server installed in another financial institution.

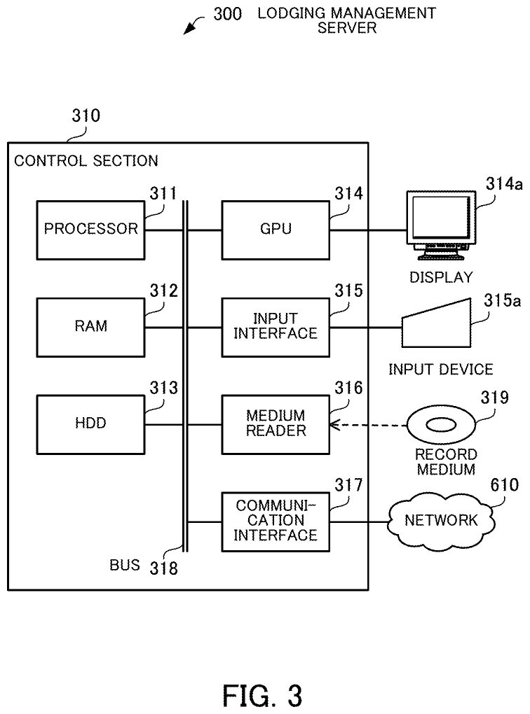

The lodging management server in the second embodiment will now be described by the use of FIG. 3. FIG. 3 illustrates an example of a hardware configuration of the lodging management server in the second embodiment.

The lodging management server 300 includes a control section 310. The control section 310 includes a processor 311, a random access memory (RAM) 312, an HDD 313, a graphics processing unit (GPU) 314, an input interface 315, a medium reader 316, and a communication interface 317. The whole of the lodging management server 300 is controlled by the processor 311. The RAM 312 and a plurality of peripheral devices are connected to the processor 311 via a bus 318. The processor 311 may be a multiprocessor. The processor 311 is a central processing unit (CPU), a micro processing unit (MPU), a digital signal processor (DSP), an application specific integrated circuit (ASIC), a programmable logic device (PLD), or the like. Furthermore, the processor 311 may be a combination of two or more of a CPU, an MPU, a DSP, an ASIC, and a PLD.

The PAM 312 is used as a main storage of the lodging management server 300. The RAM 312 temporarily stores at least part of an operating system (OS) program or an application program executed by the processor 311. In addition, the RAM 312 stores various pieces of data which the processor 311 needs for performing a process.

The plurality of peripheral devices connected to the bus 318 are the HDD 313, the GPU 314, the input interface 315, the medium reader 316, and the communication interface 317.

The HDD 313 magnetically writes data to and reads out data from a built-in disk. The HDD 313 is used as an auxiliary storage of the lodging management server 300. The HDD 313 stores the OS program, application programs, and various pieces of data. A solid state drive (SSD) may be used in place of the HDD 313. A semiconductor memory, such as a flash memory, may be used as an auxiliary storage.

The GPU 314 outputs an image to a display 314a connected to the lodging management server 300 in accordance with an instruction from the processor 311. Any kind of display may be used as the display 314a. For example, a cathode ray tube (CRT) display, a liquid crystal display (LCD), a plasma display, or an organic electro-luminescence (OEL) display may be used as the display 314a.

The input interface 315 acquires an input signal from an input device 315a connected to the lodging management server 300 and outputs it to the processor 311. Any kind of input device may be used as the input device 315a. For example, a mouse, a touch panel, a touch pad, a track ball, a keyboard, a remote controller, or a button switch may be used as the input device 315a. Furthermore, two or more kinds of input devices may s be connected to the lodging management server 300.

The medium reader 316 is a reader which reads a program or data recorded in a record medium 319. A magnetic disk, an optical disk, a magneto-optical disk (MO), a semiconductor memory, or the like is used as the record medium 319. A magnetic disk is a flexible disk (FD), an HDD, or the like. An optical disk is a compact disc (CD), a digital versatile disc (DVD), or the like.

For example, the medium reader 316 copies a program or data read from the record medium 319 to another record medium such as the RAM 312 or the HDD 313. For example, a read program is executed by the processor 311. The record medium 319 may be a portable record medium and be used for distributing a program or data. In addition, the record medium 310 or the HDD 313 may be referred to as a computer-readable record medium.

The communication interface 317 is connected to the network 610. The communication interface 317 transmits data to or receives data from another computer, storage unit, or communication device. The network 610 may be a wired network or a radio network.

The processing functions of the lodging management server 300 in the second embodiment are realized by adopting the above hardware configuration. Furthermore, the front desk terminal 400, the payment server 500, or the customer terminal 200 in the second embodiment is also realized by the hardware configuration of the lodging management server 300 illustrated in FIG. 3.

The above hardware configuration is an example. A combination of components may be determined properly. With the customer terminal 200, for example, the display 314a and the body may be integrally formed as a liquid crystal panel and the input device 315a and the body may be integrally formed as a touch panel. Furthermore, a needless component may be eliminated from the above components.

For example, the lodging management server 300 realizes the processing functions in the second embodiment by executing a program recorded in a computer-readable record medium. The program in which the contents of processes performed by the lodging management server 300 are described is recorded in various record media. For example, the program executed by the lodging management server 300 may be stored in the HDD 313. The processor 311 loads into the RAM 312 at least part of the program stored in the HDD 313 and executes the program. In addition, the program executed by the lodging management server 300 may be recorded in a portable record medium such as an optical disk, a memory unit, or a memory card. After the program stored in a portable record medium is installed in the HDD 313, for example, under the control of the processor 311, it is executed. Furthermore, the processor 311 may read the program directly from a portable record medium and execute it.

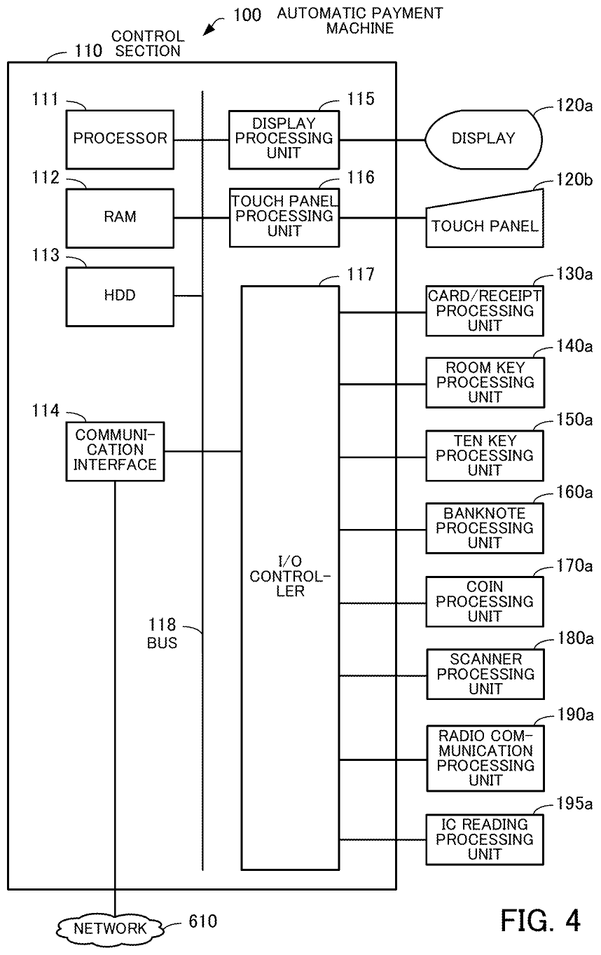

The automatic payment machine in the second embodiment will now be described by the use of FIG. 4. FIG. 4 illustrates an example of a hardware configuration of the automatic payment machine in the second embodiment.

The automatic payment machine 100 includes a control section 110, a display 120a, a touch panel 120b, a card/receipt processing unit 130a, a room key processing unit 140a, a ten key processing unit 150a, a banknote processing unit 160a, a coin processing unit 170a, a scanner processing unit 180a, a radio communication processing unit 190a, and an IC reading processing unit 195a.

The control section 110 includes a processor 111, a PAM 112, an HDD 113, a communication in 114, a display processing unit 115, a touch panel processing unit 116, and an input/output. (I/O) controller 117 which are connected to one another via a bus 118.

The processor 111 controls the whole operation. of the automatic payment machine 100. The processor 111 is a CPU, an MPU, or the like. The processor 111 stores card information (card brand name or a card handling financial institution name, a card number, and the like) acquired via the card/receipt processing unit 130a in a storage unit such as the HDD 113. Furthermore, the processor 111 transmits to the lodging management server 300 information read from a card.

The RAM 112 temporarily stores at least part of an OS program or an application program executed by the processor 111. In addition, the RAM 112 stores various pieces of data which the processor 111 needs for performing a process.

The OS program, application programs, payment information, and the like are stored in the HDD 113. Furthermore, another storage device, such as an SSD, may be used in place of the HDD 113.

The communication interface 114 is connected to the external network 610 and transmits data to or receives data from the lodging management server 300 or the like. In addition, the communication interface 114 transmits a personal identification number, payment information, or the like to or receives a personal identification number, payment information, or the like from the lodging management server 300.

The display 120a is connected to the display processing unit 115. The display 120a and the touch panel 120b make up the customer operation section 120. The display processing unit 115 displays various pieces of information including guidance as to operation on a screen of the display 120a under the control of the processor 111.

The touch panel 120b is connected to the touch panel processing unit 116. The touch panel 120b is formed in a layer over the display 120a. The touch panel processing unit 116 detects a position on a screen of the touch panel 120b which a finger of the customer touches or approaches and informs the processor 111 of the position.

The card/receipt processing unit 130a, the room key processing unit 140a, the ten key processing unit 150a, the banknote processing unit 150a, the coin processing unit 170a, the scanner processing unit 180a, the radio communication processing unit 190a, and the IC reading processing unit 195a are connected to the I/O controller 117. Under the control of the processor 111, the I/O controller 117 informs each unit connected thereto of instructions from the processor 111 and transmits information acquired from each unit to the processor 111 via the bus 118.

The card/receipt processing unit 130a is located in the card/receipt section 130 and reads information recorded on a card. The card/receipt processing unit 130a may include a magnetic information reader, a contactless integrated circuit (IC) card reader, or another reader. The card/receipt processing unit 130a prints the contents of a payment and ejects them as a statement slip (receipt).

The room key processing unit 140a is located in the room key processing section 140 and has the function of issuing a room key card. A room key has the function of shutting and opening an electronic lock on a door of a guest room in a lodging facility. The room key processing unit 140a has the function of setting a room key card according to a number of a room in a lodging facility, the date and hour of lodging, and the like.

The ten key processing unit 150a is located in the ten key input section 150 and outputs information regarding a button which the customer presses down. Information regarding a button which the customer presses down may include a personal identification number, information used for a payment process, or the like.

The banknote processing unit 160a is located in the banknote processing section 160 and controls receiving and paying a banknote and opening and closing a door in accordance with instructions from the processor 111. Furthermore, the banknote processing unit 160a also controls imaging by the short-range camera included in the banknote processing section 160. The coin processing unit 170a is located in the coin processing section 170 and controls receiving and paying a coin and opening and closing a door in accordance with instructions from the processor 111.

The scanner processing unit 100a is located in the scanner section 180 and has the function of reading an image of a passport or a bar code. For example, the scanner processing unit 180a acquires as image information the whole of the passport which the customer lays face down on the scanner section 180. Furthermore, the scanner processing unit 180a perform character recognition on the OCR region of the passport and acquires character information. (passport number, a nationality, and the like). In addition, the customer reads a screen of the customer terminal 200 on which a two-dimensional bar code is displayed as a reservation confirmation slip and reads a reservation number from the two dimensional bar code.

The radio communication processing unit 190a is located in the radio communication section 190 and has the function of communicating with a device such as the customer terminal 200. For example, the radio communication processing unit 190a may perform a process for paying hotel charges by performing payment information communication with the customer terminal 200.

The IC reading processing unit 195a is located in the IC reading section 195 and has the function of reading data recorded in the IC chip included in the passport. Furthermore, the IC reading processing unit 195a outputs the data read from the IC chip to the processor 111.

The processing functions of the automatic payment machine 100 in the second embodiment are realized by adopting the above hardware configuration. The automatic payment machine 10 according to the first embodiment is also realized by adopting the hardware configuration of the automatic payment machine 100 illustrated in FIG. 4. The above configuration is an example and a combination of components of the automatic payment machine 100 may be determined properly.

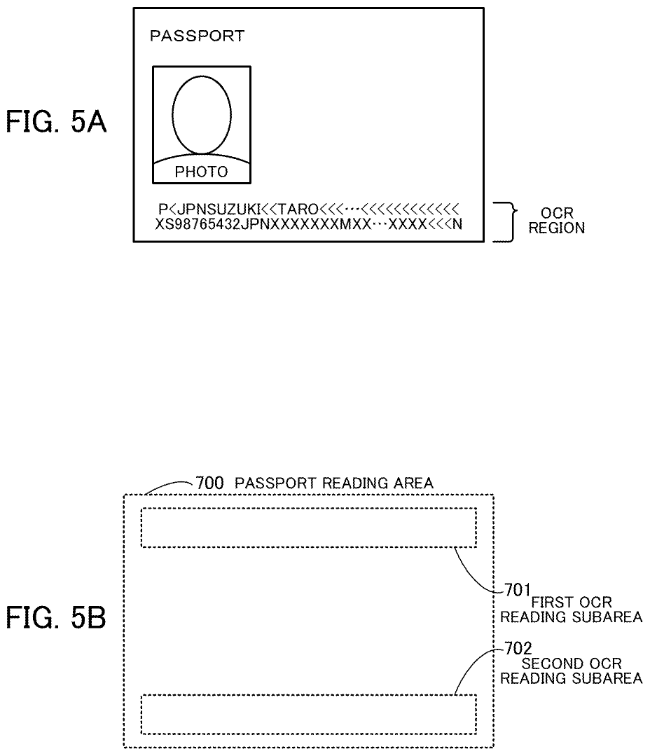

An example of a passport image which the automatic payment machine 100 in the second embodiment reads and a reading area will now be described by the use of FIGS. 5A and 5B. FIGS. 5A and 5B illustrate an example of a passport image and a passport reading area in the second embodiment.

FIG. 5A illustrates an example of an image of a passport to be read by the scanner section 180. The automatic payment machine 100 acquires image data of a page of the passport including a photograph via the scanner section 180. Furthermore, the automatic payment machine 100 performs character recognition on an OCR region (machine readable zone including 2 lines of 44 characters each) of the passport image illustrated in FIG. 5A and acquires information. Hereinafter the page of the passport including the photograph will also be stated as a reading target page.

FIG. 5B illustrates an example of a passport reading area 700. When the scanner section 180 reads the passport, the scanner section 180 sets as the passport reading area 700 (passport reading area) an area for reading the passport. The passport reading area 700 includes a first OCR reading subarea 701 (first character information reading subarea) and a second OCR reading subarea 702 second character information reading subarea). The scanner section 180 performs character recognition process not on the whole of the passport image but on the first OCR reading subarea 701 and the second OCR reading subarea 702 and acquires character information. The size of the passport reading area 700 is approximately equal to or larger than that of a page to be read. Furthermore, the passport reading area 700 is approximately rectangular and is an area on which an image is read.

A position in which the passport reading area 700 is set is changeable according to the size of the scanner section 180. For example, if the size (A4 size, for example) of the scanner section 180 is larger than a page of the passport to be read, then the, passport reading area 700 may be set at the lower right corner of the scanner section 180 (at the corner this side on the right of the scanner section 180 of the automatic payment machine 100). In addition, a position in which the passport reading area 700 is set is not limited to the lower right-hand corner of the scanner section 180. The passport reading area 700 may be set on any of the: four corners of the: scanner section 180. Furthermore, the passport reading area 700 may be set according to the external shape of the automatic payment machine 100 in a position which is easy for the customer to use.

The first OCR reading subarea 701 and the second OCR reading subarea 702 are sufficiently large to acquire character information which consists of two lines of 44 characters each and which is included in the OCR region. The first OCR reading subarea 701 and the second OCR reading subarea 702 are smaller than the passport reading area 700. For example, when the passport is laid on the scanner section 180 in a reverse direction, the OCR region is situated near the top of the passport reading area 700. At this time the first OCR reading subarea 701 is used for reading the OCR region. The first OCR reading subarea 701 extends approximately parallel to the top (upper lone side) of the passport reading area 700 and is approximately rectangular.

When the passport is laid on the scanner section 180 in a forward direction and the OCR region is situated near the bottom of the passport reading area 700, the second OCR reading subarea 702 is used for reading the OCR region. The second OCR reading subarea 702 extends approximately parallel to the bottom (lower long side) of the passport reading area 700 and is approximately rectangular.

As stated above, the passport reading area 700 includes the upper first OCR reading subarea 701 and the lower second OCR reading subarea 702 used for reading the character information included in the OCR region. Therefore, even when the page of the passport to be read is laid upside down, the character information which consists of two lines of 44 characters each is acquired.

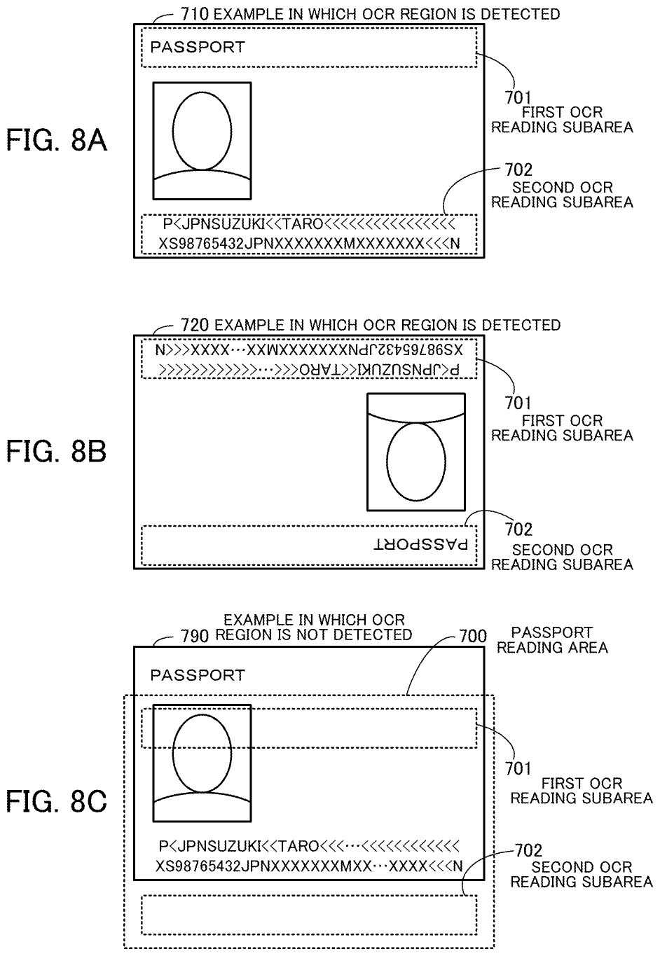

The meaning of a state in which the passport is laid on the scanner section 180 in the reverse direction is as follows. The direction of a photograph on the page of the passport to be read is a downward direction (photograph is turned around by 180 degrees) and the passport is laid on the scanner section 180 in this state. Furthermore, the meaning of a state in which the passport is laid on the scanner section 180 in the forward direction is as follows. The direction of the photograph on the page of the passport to be read is an upward direction (photograph is not turned around) and the passport is laid on the scanner section 180 in this state. A state in which the OCR region (MRZ) is read on the first OCR reading subarea 701 and the second OCR reading subarea 702 will be described by the use of FIGS. 8A to 8C.

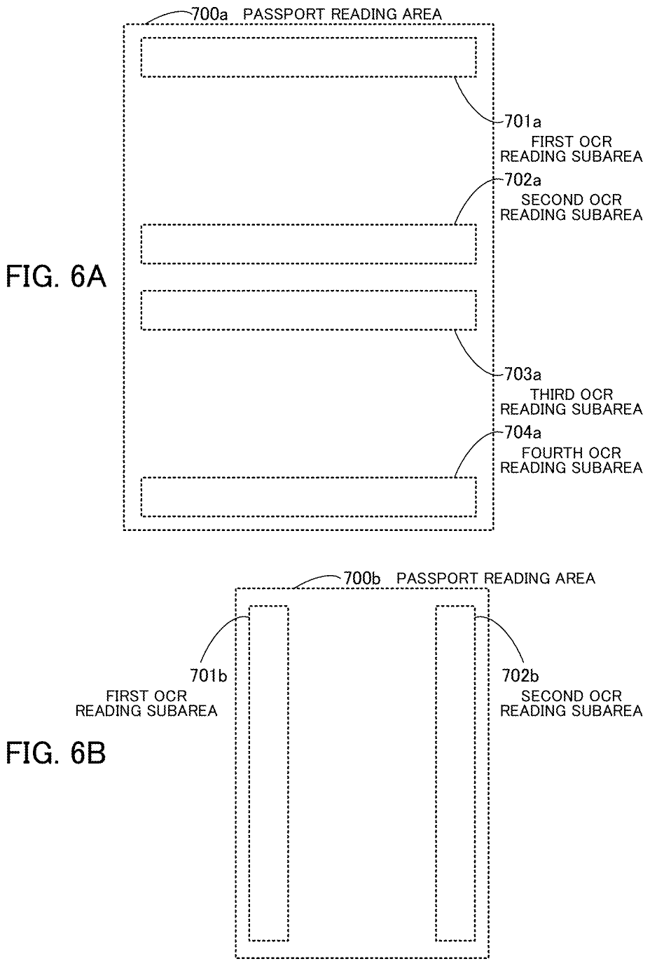

An example of the reading area in the second embodiment will now be described by the use of FIGS. 6A and 6B. FIGS. 6A and 6B illustrate an example of variations of the reading area in the second embodiment (part 1).

FIG. 6A illustrates an example of a passport reading area 700a. The passport reading area 700a is equal to the passport reading area 700 in that it is used for reading a passport. The passport reading area 700a differs from the passport reading area 700 in that the size of the passport reading area 700a is set to passport spread size (two times the size of the passport reading area 700) and in that the passport reading area 700a includes four OCR reading subareas (first OCR reading subarea 701a, a second OCR reading subarea 702a, a third OCR reading subarea 703a, and a fourth OCR reading subarea 704a). The passport reading area 700a is obtained by joining two passport reading areas 700.

When the customer opens the passport and lays it face down to perform passport reading operation, a pace to be read may be placed upside down. In order to cope with this case, the passport reading area 700a includes four subareas for reading the OCR region. By doing so, the OCR region is read whether the page to be read is placed on the upside or downside.

FIG. 3 illustrates an example of a passport reading area 700b. The passport reading area 700b is equal to the passport reading area 700 in that it is used for reading a passport. The passport reading area 700b differs from the passport reading area 700 in its direction. The passport reading area 700b is obtained by turning the passport reading area 700 counterclockwise by 90 degrees. In other words, the passport reading area 700b is set by turning around the passport reading area 700 by 90 degrees with respect to a passport reading surface included in the scanner section 180.

When the customer opens the passport and lays it face down to perform passport reading operation, the passport may be laid sideways. In order to cope with this case, the passport reading area 700b is obtained by turning around an area for reading the OCR region by 90 degrees. By doing so, the OCR region is read even when the page to be read is placed sideways. Furthermore, the passport reading area 700b includes two subareas on the left and right sides for reading the character information included in the OCR region. As a result, even when the page of the passport to be read is positioned in a laterally inverted state, the character information which consists of two lines of 44 characters each is acquired.

The passport reading area 700b is a simple example in which the passport reading area 700 is turned around. A passport reading area obtained by turning around the passport reading area 700 by another angle may be used. A passport reading area may be set according to the shape of the scanner section. 180 or the design of an enclosure of the automatic payment machine 100.

FIGS. 6A and 6B illustrate a simple example of variations of the reading area. A plurality of passport reading areas 700 may be set on the scanner section 180. For example, the passport reading areas 700, 700a, and 700b may be arranged on the scanner section 180. In this case, the passport reading areas 700, 700a, and 700b may be distributedly arranged or be arranged so as to overlap.

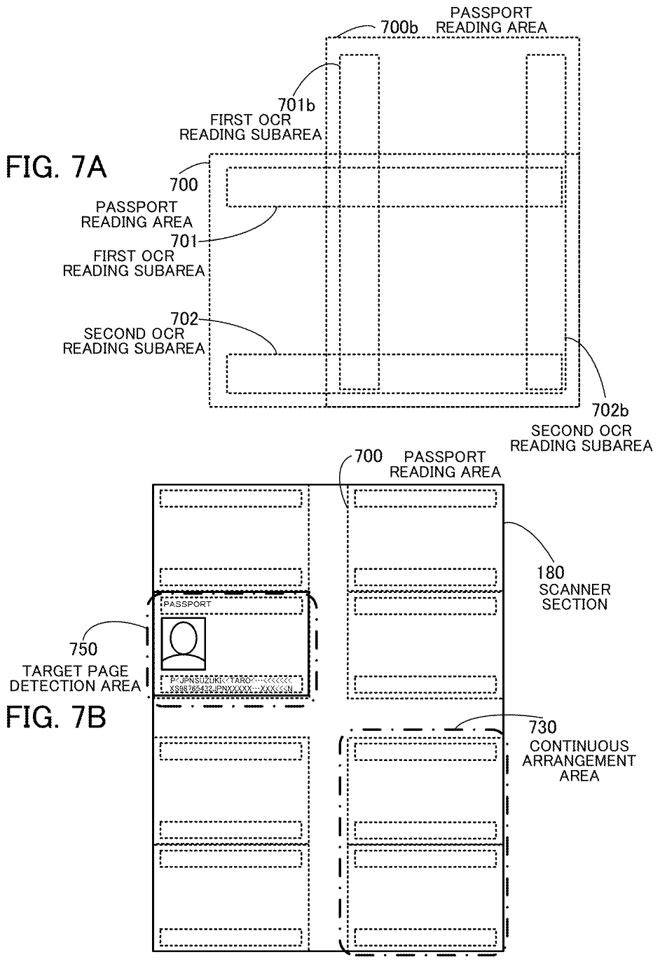

An example of the reading area in the second embodiment will now be described by the use of FIGS. 7A and 7B. FIGS. 7A and 7B illustrate an example of variations of the reading area in the second embodiment (part 2).

FIG. 7A illustrates an example in which the passport reading area 700 and the passport reading area 700b are arranged so as to overlap. The passport reading area 700 and the passport reading area 700b are set on the scanner section 180 so that they will overlap. By doing so, the OCR region is detected it the passport is laid both vertically and horizontally.

For example, if the passport is laid vertically, then the automatic payment machine 100 detects the character information (which consists of two lines of 44 characters each) on the first OCR reading subarea 701 or the second. OCR reading subarea 702 and acquires an image within the passport reading area 700 as image data of a page to be read. Furthermore, if the passport is laid horizontally, then the automatic payment machine 100 detects the character information (which consists of two lines of 44 characters each) on the first OCR reading subarea 701b or the second OCR reading subarea 702b and acquires an image within the passport reading area 700b as image data of a page to be read. In other words, if a plurality of OCR reading subareas (four OCR reading subareas in FIG. 7A) are set, then the automatic payment machine 100 takes out an image within a passport reading area corresponding to an OCR reading subarea on which the character information is detected, acquires the image as image data of a page to be read, and saves the image in a storage unit. As a result, the automatic payment machine 100 acquires image data of a page to be read without a mistake in direction in which an image is taken out.

FIG. 7B illustrates an example in which areas obtained by continuously arranging the passport reading areas 700 are distributedly arranged on the four corers of the scanner section 180.

A continuous arrangement area 730 is formed by vertically spreading the passport reading areas 700 like tiles and continuous arranging the passport reading areas 700. In this example, the continuous arrangement area 730 is formed by continuously arranging the two passport reading areas 700 vertically. However, the passport reading areas 700b may continuously be arranged horizontally like: tiles. Furthermore, if a plurality of continuous arrangement areas 730 are set, then they may be arranged so as to overlap.

A page of the passport to be read is detected on a target page detection area 750. The automatic payment machine 100 acquires an image: within the target page detection area 750 as image data of the page to be read.

If a plurality of OCR reading subareas (16 OCR reading subareas in FIG. 7B) are set, then the automatic payment machine 100 takes out an image within a passport reading area corresponding to an OCR reading subarea on which the character information is detected, acquires the Image as image data of the page to be read, and saves the image in a storage unit. As a result, the automatic payment machine 100 eliminates an image within another area and acquires as image data only an image within an area which needs to be saved as a passport image.

The passport reading areas 700a may be distributedly arranged on the four corners of the scanner section 180 of the automatic payment machine 100. The passport in an open state may be laid on any of the four corners of the scanner section 180 or the passport may be laid upside down. Even in these cases, the OCR region is detected by distributedly arranging the passport reading areas 700a on the four corners of the scanner section 180.

An example of detecting the OCR region of the passport by the automatic payment machine 100 in the second embodiment will now be described by the use of FIGS. 8A to 8C. FIGS. 8A to 8C illustrate an example of detecting the OCR region of the passport in the second embodiment.

FIG. 8A illustrates an example 710 in which the OCR region is detected. The scanner section 180 takes out an image included in the second OCR reading subarea 702, performs character recognition, and acquires the character information which consists of two lines of 44 characters each. The character information “PASSPORT” is recognized from an image included in the first OCR reading subarea 701. However, because these pieces of character information differ from the character information which consists of two lines of 44 characters each, they are discarded.

FIG. 8B illustrates an example 720 in which the OCR region is detected. The scanner section 180 takes out an image included in the first OCR reading subarea 701, turns around the image by 180 degrees to make the direction of the image the forward direction, performs character recognition, and acquires the character information which consists of two lines of 44 characters each.

FIG. 8C illustrates an example 790 in which the OCR region is not detected. The scanner section 180 takes out images included in the first OCR reading subarea 701 and the second OCR reading subarea 702 and performs character recognition. However, a state in which the scanner section 180 fails to acquire the character information that consists of two lines of 44 characters each arises. If the scanner section 180 fails to the character information which consists of two lines of 44 characters each, then the automatic payment machine 100 displays on the customer operation section 120 a screen which gives instructions to lay the passport so that it is readable.

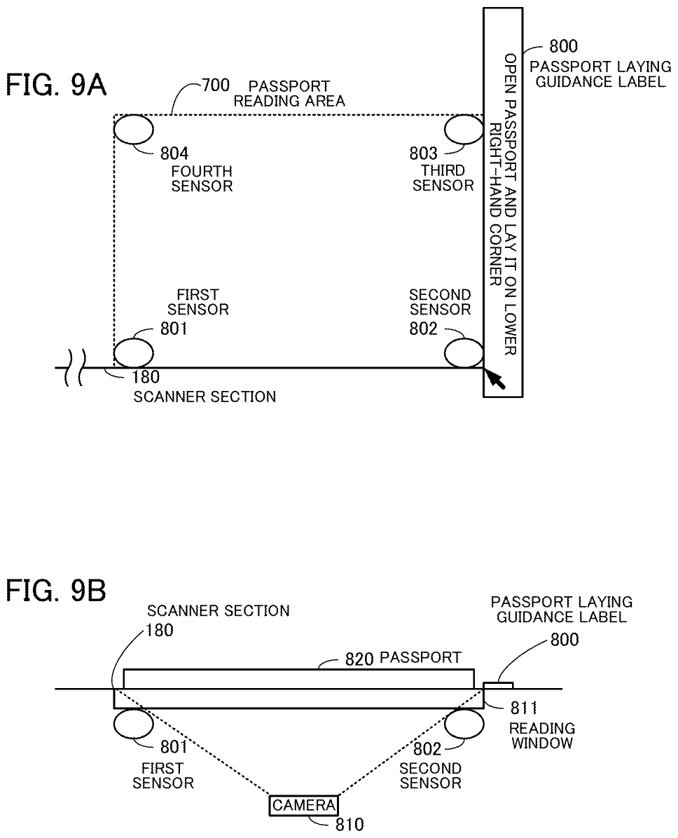

An example of a sensor of the scanner section 180 in the second embodiment will now be described by the use of FIGS. 9A and 9B. FIGS. 9A and 9B illustrate an example of a sensor of the scanner section in the second embodiment.

FIG. 9A illustrates an example of the arrangement of a four-corner sensor included in the scanner section 180. FIG. 9A illustrates the scanner section 180 in planar view. In order words, FIG. 9A is a bird's-eye view of the scanner section 180 of the automatic payment machine 100. The external shape of the scanner section 180 is not illustrated. The size of the scanner section 180 may be approximately equal to or larger than that of the passport, be A4 size, or be another size.

The four-corner sensor is an optical sensor which detects the four corners of a page of a passport to be read. The four-corner sensor includes a first sensor 801, a second sensor 802, a third sensor 803, and a fourth sensor 804, that is to say, four sensors. All or part of the sensors of the four-corner sensor are also stated as detectors. The four-corner sensor is arranged on the four corners of the passport reading area 700. The first sensor 801 is arranged under the lower left-hand corner of the passport reading area 700. The second sensor 802 is arranged under the lower right-hand corner of the passport reading area 700. The third sensor 803 is arranged under the upper right-hand corner of the. passport reading area 700. The fourth sensor 804 is arranged under the upper left-hand corner of the passport reading area 700. The above arrangement of the four-corner sensor is a simple example. Another arrangement method may be adopted. If the four-corner sensor detects that an object is laid over each sensor in the scanner section 180, then the four-corner sensor informs the processor 111 of an output “on” signal.

If the: passport reading area 700 is set on the lower right-hand corner of the scanner section 180, then the four-corner sensor is arranged according to the passport reading area 700 in a position in which the four-corner sensor detects a page to be read laid on the lower right-hand corner of the scanner section 180.

Furthermore, when the passport reading area 700 is set, a passport laving guidance label 800 is stuck on the right side of the scanner section 180 on the enclosure of the automatic payment machine 100. Instructions for guiding a customer to a position in which the passport is to be laid are displayed on the passport laying guidance label 800. An arrow symbol indicative of the lower right-hand corner is printed on the passport laying guidance label 800 so that a page of the passport to be read laid will be laid on the lower right-hand corner of the scanner section 180. However, display performed by these characters and symbol is a simple example. Another display method may be adopted.

FIG. 9B illustrates an example of the arrangement of the four-corner sensor and a camera included in the scanner section 180. FIG. 9B illustrates the scanner section. 180 in side view. The scanner section 180 includes a camera 810 under the four-corner sensor (only the first sensor 801 and the second sensor 802 of the four-corner sensor are illustrated in FIG. 9B and the other sensors are not illustrated in FIG. 9B). The camera 810 photographs a page of a passport 820 to be read laid on a reading window 811. The reading window 811 is an area of the enclosure of the automatic payment machine 100 on which an object to be read is laid and is a plate made of a light-transmitting material (such as colorless and transparent glass or acrylic). The automatic payment machine 100 detects the page to be read by the four-corner sensor, photographs the page to be read by the camera 810, acquires image data, and performs character recognition on the basis of the image data.

Some automatic payment machines 100 include the above four-corner sensor, and other automatic payment machines 100 do not include the above four-corner sensor. A passport reading process performed by an automatic payment machine 100 including the above four-corner sensor may differ from a passport reading process performed by an automatic payment machine 100 not including the above four-corner sensor.

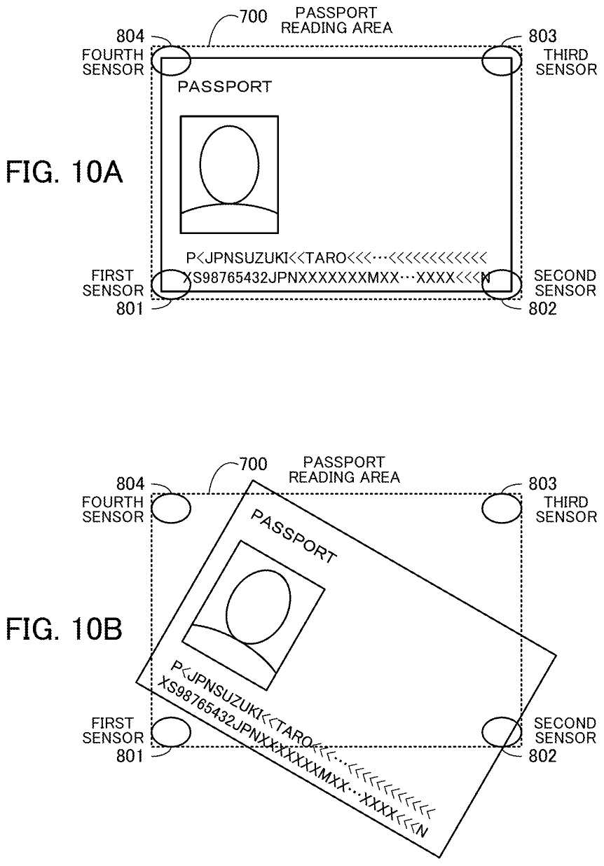

An example of detecting a passport in the scanner section 180 in the second embodiment will now be described by the use of FIGS. 10A and 10B. FIGS. 10A and 10B illustrate an example of detecting a passport by the sensor in the second embodiment.

FIG. 10A illustrates an example of a case where a passport is detected by the four-corner sensor included in the scanner section 180. In FIG. 10A, all the sensors of the four corner sensor detect an object laid and output “on”. In this example, detection succeeds. The scanner section 180 receives notice of “on” from all the sensors of the four-corner sensor and gives the camera 810 instructions to photograph the object.

FIG. 10B illustrates an example of a case where a passport is not detected by the four-corner sensor included in the scanner section 180. In FIG. 10B, only the second sensor 802 detects an object laid and output “on”. The first sensor 801, the third sensor 803, or the fourth sensor 804 does not detect the object laid and does not output “on”. In FIG. 10B, detecting the object is unsuccessful. Because the scanner section 180 does not receive notice of “on” from all the sensors of the four-corner sensor, the scanner section 180 does not give the camera 810 instructions to photograph the object.

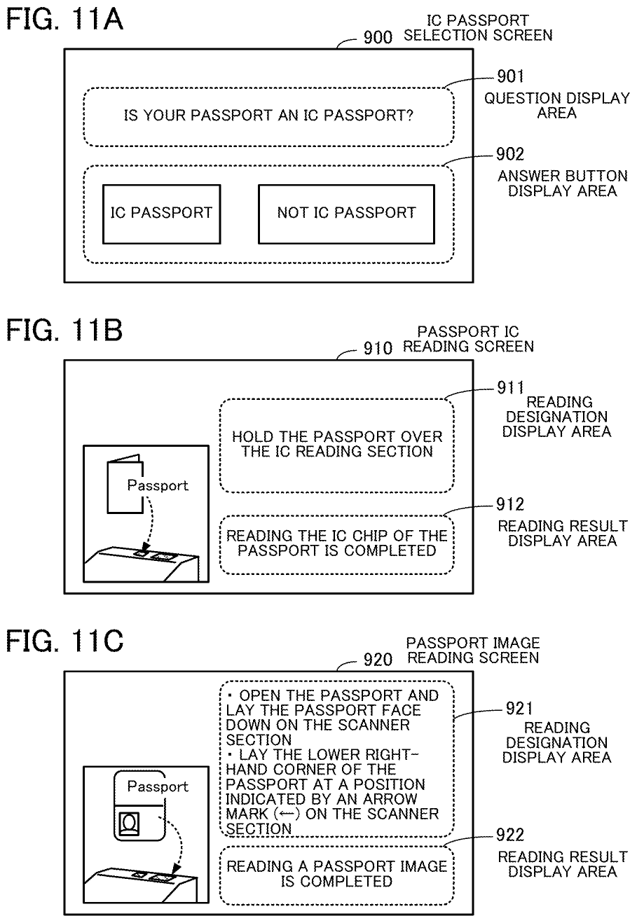

An example of a display screen on the automatic payment machine 100 in the second embodiment will now be described by the use of FIGS. 11A to 11C. FIGS. 11A to 11C illustrate an example of a display screen on the automatic payment machine in the second embodiment.

FIG. 11A illustrates an example of an IC passport selection screen 900 displayed on the customer operation section 120 of the automatic payment machine 100. The IC passport selection screen 900 inquires of a customer whether the passport is an IC passport, and accepts an answer. The IC passport selection screen 900 includes a question display area 901 and an answer button display area 902.

A question sentence for inquiring whether or not the passport is an IC passport is displayed on the question display area 901. For example, the sentence “Is your passport an IC passport?” is displayed on the question display area 901.

Buttons for making an answer to whether or not the passport is an IC passport are displayed on the answer button display area 902. For example, a button. (IC passport button) on which “IC passport” is displayed and a button (non-IC passport button) on which “not IC passport” is displayed are displayed on the answer button display area 902.

Words displayed on the IC passport selection screen 900 are not limited to Japanese words and may e changed according to an input (speech input or an input by operation via the customer operation section 120) from a customer. The automatic payment machine 100 has dictionary data in a storage unit, such as the HDD 113, and accommodates multilingual display. The same applies to each screen described later.

FIG. 11B illustrates an example of a passport IC reading screen 910 displayed on the customer operation section 120 of the automatic payment machine 100. The passport IC reading screen 910 gives instructions to perform the: operation of reading an IC chip included in the IC passport, and displays a reading result.

The passport IC reading screen 910 includes a reading designation display area 911 and a reading result display area 912. Furthermore, the passport IC reading screen 910 may include a graphic description of the operation of holding the passport over the IC reading section 195 of the automatic payment machine 100 and making the IC reading section 195 read the IC chip.

Instructions to perform the operation of reading the IC chip included in the. IC passport are displayed on the reading designation display area 911. For example, the sentence “Hold the passport over the IC reading section” is displayed on the reading designation display area 911.

The result of reading the IC chip is displayed on the reading result display area 912. For example, if reading the IC chip succeeds, then the sentence “Reading the IC chip of the passport is completed” is displayed on the reading result display area 912. In addition, if reading the IC chip is unsuccessful, the sentences “Reading the IC chip of the passport is unsuccessful. Open the passport and lay the passport face down on the scanner section to read a passport image.” are displayed on the reading result display area 912.

FIG. 11C illustrates an example of a passport image reading screen 920 displayed on the customer operation section 120 of the automatic payment machine 100. The passport image reading screen 920 gives instructions to perform the operation of reading a page of the passport including a photograph, and displays a reading result.

The passport image reading screen 920 includes a reading designation display area 921 and a reading result display area 922. Furthermore, the passport image reading screen 920 may include a graphic description of the operation of finding the page of the passport including the photograph, laying the passport face down on the scanner section 180 of the automatic payment machine 100, and making the scanner section 180 read a passport image.

Instructions to perform the operation of reading a passport image are displayed on the reading designation display area 921. For example, the sentences “⋅Open the passport and lay the passport face down on the scanner section. ⋅Lay the lower right-hand corner of the passport at a position indicated by an arrow mark (←) on the scanner section.” are displayed on the reading designation display area 921. Sentences displayed on the reading designation display area 921 may be set according to the shape of the scanner section 180, a position in which the passport reading area 700 is set, the position of the four-corner sensor, or the like.

The result of reading a passport image is displayed on the reading result display area 922. For example, if reading a passport image succeeds, then the sentence. “Reading a passport image is completed.” is displayed on the reading result display area 922. In addition, if reading a passport image is unsuccessful, then the sentences “Reading a passport image is unsuccessful. To read a passport image again, open the passport and lay the passport face down on the lower right-hand corner of the scanner section.” are displayed on the reading result display area 922. The automatic payment machine 100 determines, on the basis of an output of the four-corner sensor or the result of character recognition, whether or not image reading succeeds, and displays a reading result.

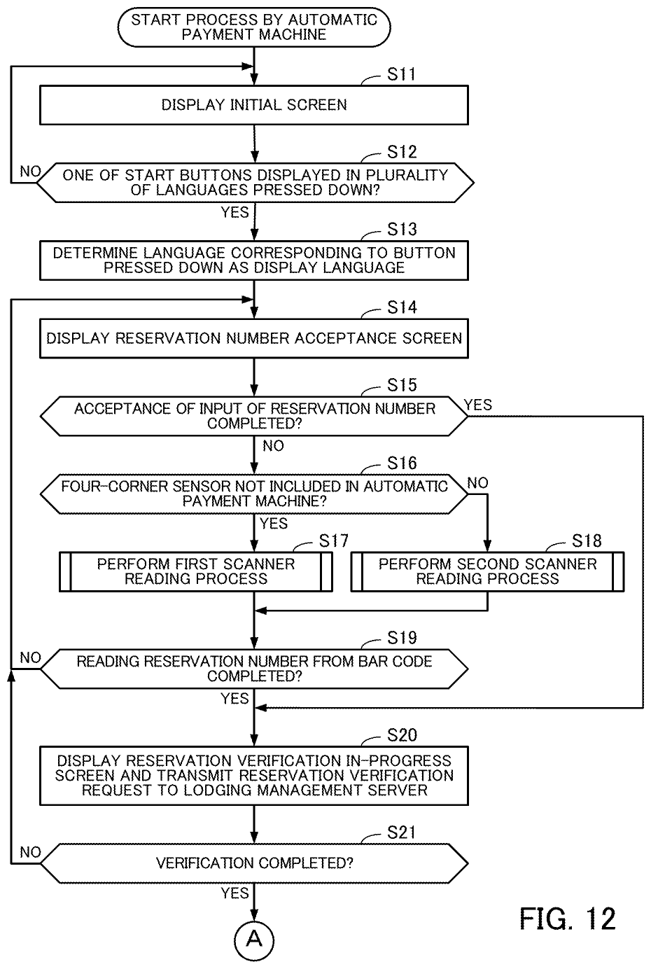

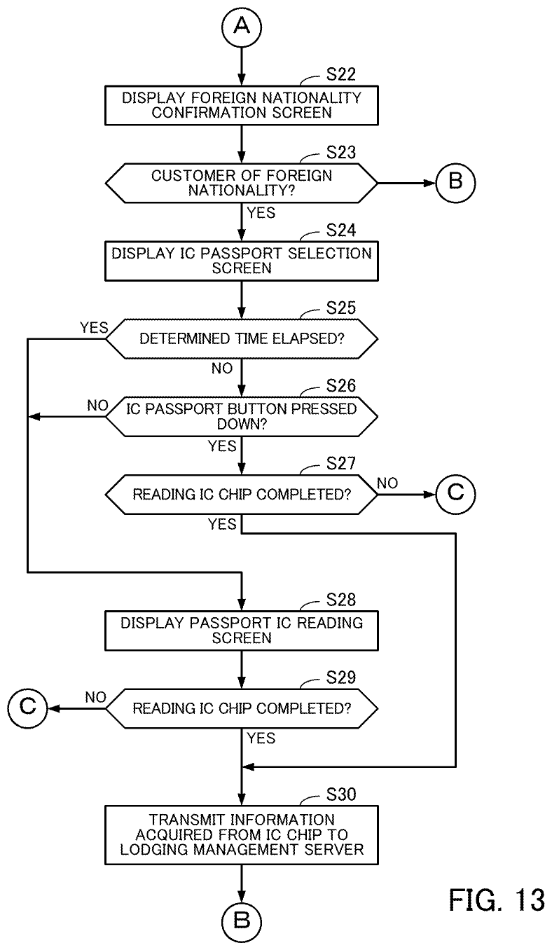

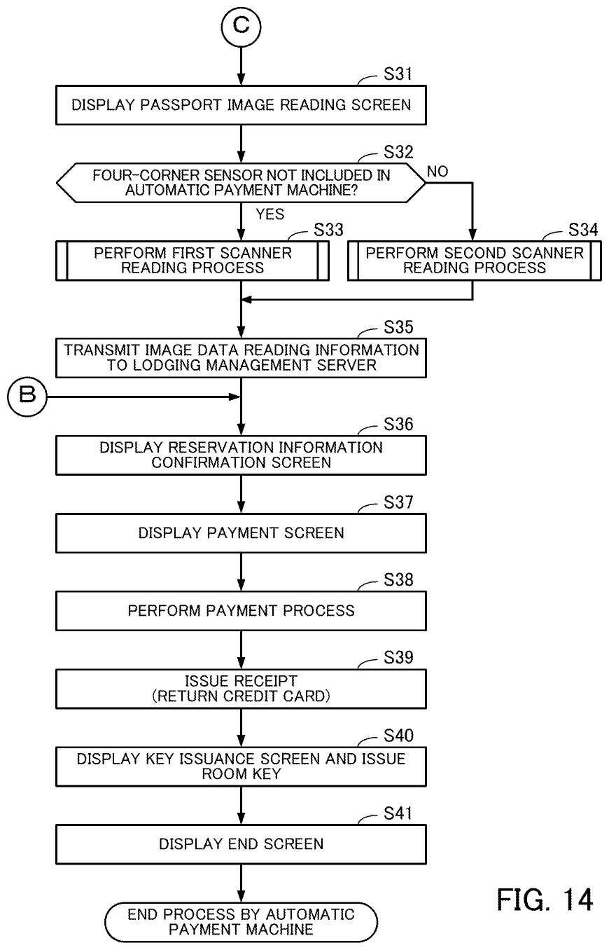

A process by the automatic payment machine in the second embodiment will now be described by the use of FIGS. 12 through 14. FIG. 12 illustrates an example of a flow chart illustrative of a process by the automatic payment machine in the second embodiment (part 1). FIG. 13 illustrates an example of a flow chart illustrative of a process by the automatic payment machine in the second embodiment (part 2). FIG. 14 illustrates an example of a flow chart illustrative of a process by the automatic payment machine in the second embodiment (part 3).

In a process by the automatic payment machine, the automatic payment machine 100 accepts an input from a customer, reads a passport, displays a screen according to the input or the like accepted from the customer, and issues a room key.

The control section 110 (processor 111) of the automatic payment machine 100 accepts a speech input or a button input from a customer and performs a process by the automatic payment machine.

(Step S11) The control section 110 displays on the display 120a an initial screen (not illustrated) on which an input is accepted from a customer. The initial screen includes buttons on which the: word “start” is displayed in a plurality of languages.

(Step S12) The control section 110 determines whether or not one of the start buttons displayed in the plurality of languages on the initial screen is pressed down via the touch panel 120b. If one of the start buttons is pressed down, then the control section 110 proceeds to step S13. If none of the start buttons is pressed down, then the control section 110 proceeds to step S11.

(Step S13) The control section 110 determines a language (display language) displayed on a screen on the basis of the button pressed down in step S12. For example, if the button on which “START” is displayed in English is pressed down, then the control section 110 selects English as display language. Furthermore, if the button on which a Japanese word for “start” is displayed is pressed down, then the control section 110 selects Japanese as display language.

(Step S14) The control section 110 displays a reservation number acceptance screen on the display 120a. The control section 110 displays the sentences “Input, your reservation number. Alternatively, display a bar code by a reservation application in a smartphone and hold the smartphone over a passport reader.” on the display 120a as the reservation number acceptance screen. The reservation number acceptance screen includes not only the above sentences but also, for example, an illustration of a method for inputting a reservation number or a method for holding a smartphone over the scanner section 180 and making the scanner section 180 read a bar code.

If a lodging reservation is successfully verified on the basis of information acquired from a passport, then the control section 110 may omit steps S14 through S19. In this case, the control section 110 verifies the lodging reservation by the use of passport information, such as a passport number, the date of birth, and a name, acquired from the passport in place of the reservation number.

(Step S15) The control section 110 determines whether or not acceptance of an input of the reservation number via the touch panel 120, is completed. If acceptance of an input of the reservation number is completed, then the control section 110 proceeds to step S20. If acceptance of an input of the reservation number is not completed, then the control section 110 proceeds to step S16.

The control section 110 stores in advance a determined digit number in a storage unit as the digit number of the reservation number. If a number inputted reaches the determined digit number, then the control section. 110 determines that acceptance of an input of the reservation number is completed.

(Step S16) If the scanner section 180 does not include a four-corner sensor (first sensor 801, the second sensor 802, the third sensor 803, and the fourth sensor 804), then the control section 110 proceeds to step 217. If the scanner section 180 includes a four-corner sensor, then the control section 110 proceeds to step 218.

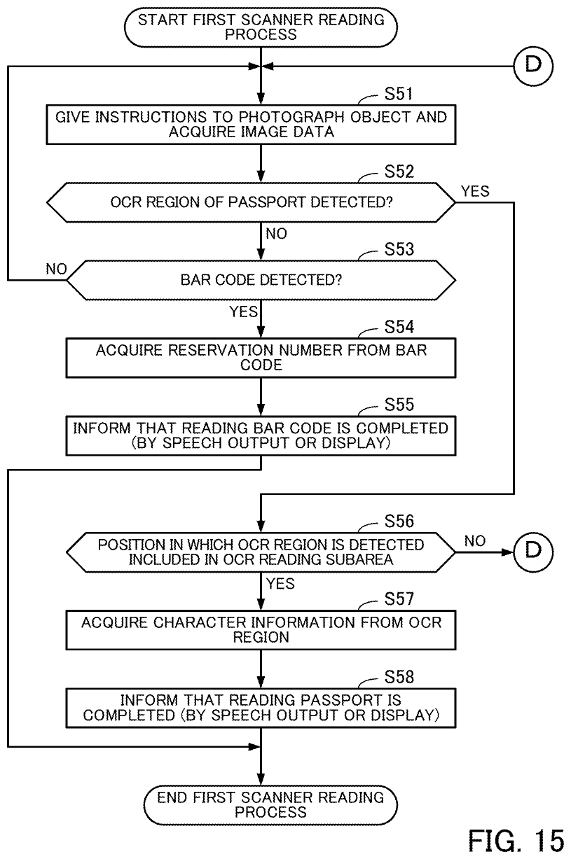

(Step S17) The control section 110 performs a first scanner reading process. In the first scanner reading process, the scanner processing unit 180a photographs an object (smartphone on which a bar code is displayed, a reservation slip on which a bar code is printed, the passport, or the like) laid on the scanner section 180 and performs reading. The first scanner reading process will be described later by the use of FIG. 15.

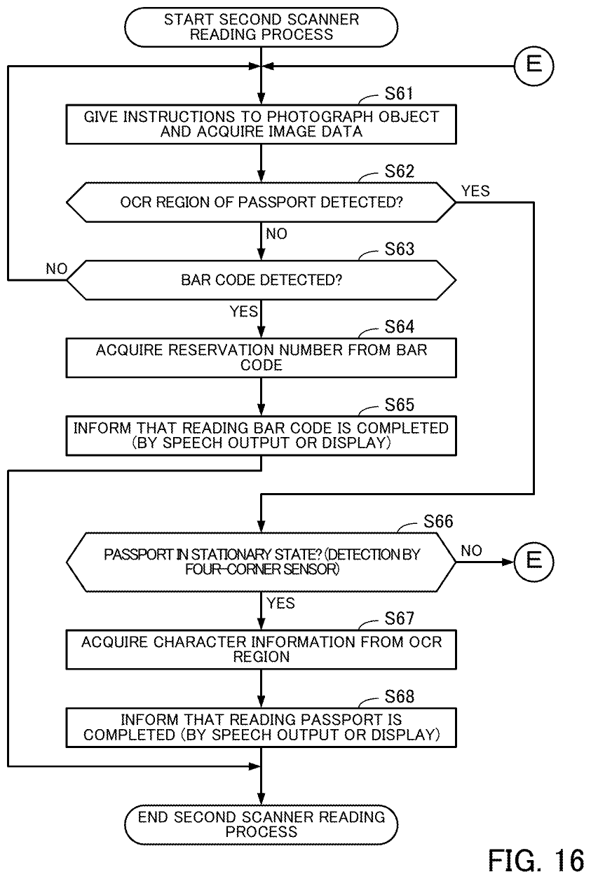

(Step S18) The control section 110 performs a second scanner reading process. In the second scanner reading process, the scanner processing unit 180a photographs an object laid on the scanner section 180 and performs reading. In the second scanner reading process, the scanner processing unit. 180a detects the passport by the use of the four-corner sensor. The second scanner reading process will be described later by the use of FIG. 16.

(Step S19) The control section 110 reads the scanner processing unit 180a the bar code displayed on the customer terminal 200 or the bar code printed on the reservation slip and determines whether or not reading the reservation number from the bar code is completed. If reading the reservation number from the bar code is completed, then the control section 110 proceeds to step S20. If reading the reservation number from the bar code is not completed, then the control section 110 proceeds to step S14.

(Step S20) The control section 110 displays a reservation verification in-progress screen on the display 120a and transmits a reservation verification request and the reservation number to the lodging management server 300.

(Step S21) The control section 110 determines whether or not it receives from the lodging management server 300 notice that verification of the reservation number is completed. If the control section 110 receives notice that verification of the reservation number is completed, then the control section 110 proceeds to step S22. If the control section 110 receives notice that verification of the reservation number is impossible, then the control section 110 proceeds to step S14.

If the control section. 110 receives from the lodging management server 300 the notice that verification of the reservation number is impossible, then the control section 110 displays the sentences “Verification of the reservation number is impossible. Input your reservation number again” on the display 120a and proceeds to step S14.

The control section 110 receives from the lodging management server 300 the notice that verification of the reservation number is completed and reservation information.

(Step S22) The control section 110 displays a foreign nationality confirmation screen on the display 120a. The foreign nationality confirmation screen inquires of the customer whether or not the customer is of foreign nationality. The foreign nationality confirmation screen displays a sentence for inquiring of the customer whether or not the customer is of foreign nationality, an answer button which indicates foreign nationality, and an answer button which indicates non-foreign nationality.

(Step S23) The control section 110 determines whether or not the answer button which indicates foreign nationality is pressed down via the touch panel 120b. If the answer button which indicates foreign nationality is pressed down, then the control section 110 proceeds to step S24. If the answer button which indicates non-foreign nationality is pressed down, then the control section 110 proceeds to step S36. If the customer is not of foreign nationality, then there is no need to read the customer' passport. Accordingly, the control section 110 proceeds to a reservation information confirmation process without performing a passport reading process.

(Step S24) The control section 110 displays the IC passport selection screen 900 on the display 120a.

(Step S25) The control section 110 determines whether or not determined time (two minutes, for example) has elapsed in a state in which a button displayed on the answer button display area 902 is not pressed down. If the determined time has elapsed, then the control section 110 proceeds to step S28. If the determined time has not elapsed, then the control section 110 proceeds to step S26.

(Step S26) The control section 110 determines whether or not the IC passport button is pressed down via the touch panel 120b. If the IC passport button is pressed down, then the control section 110 proceeds to step S27. If the IC passport button is not pressed down, then the control section 110 proceeds to step S28.

(Step S27) The control section 110 acquires via the IC reading processing unit 195a information stored in an IC chip included in the passport, and determines whether or not reading the IC chip is completed. If reading the IC chip is completed, then the control section 110 proceeds to step S30. If reading the IC chip is not completed, then the control section 110 proceeds to step S31.

Even if the passport is an IC passport, there is a case where information is not read from an IC chip (due to damage to the IC chip, the influence of magnetism, or the like). Accordingly, if information is not read out from the IC chip included in the passport, then the control section 110 proceeds to a process for acquiring image data of the passport.

(Step S28) The control section 110 displays the passport IC reading screen 910 on the display 120a.

This step is performed for the customer who is unaccustomed to handling the passport. This step is performed regardless of whether the passport is an IC passport or not. This step is performed when determined time elapses in a state in which the customer does not provide an input on the IC passport selection screen 900. The control section 110 displays the passport IC reading screen 910. By doing so, the customer is made to hold the passport over the IC reading section 195 and whether or not the passport is an IC passport is determined.

(Step S29) The control section 110 acquires via the IC reading processing unit 195a information stored in an IC chip included in the passport, and determines whether or not reading the IC chip is completed. If reading the IC chip is completed, then the control section 110 proceeds to step S30. If reading the IC chip is not completed, then the control section 110 proceeds to step S31.

(Step S30) The control section 110 transmits to the lodging management server 300 the information acquired from the IC chip included in the passport. The lodging management server 300 stores the information received from the control section 110 in a storage unit such as the HDD 313.

(Step S31) The control section 110 displays the passport image reading screen 920 on the display 120a. If the passport is not an IC passport or if information is not read from the IC chip, then the control section 110 photographs a page of the passport to be read and acquires image data.

(Step S32) If the scanner section 180 does not include a four-corner sensor, then the control section 110 proceeds to step S33. If the scanner section 180 includes a four-corner sensor, then the control section 110 proceeds to step S34.

(Step S33) The control section 110 performs a first scanner reading process. The first scanner reading process will be described later by the use of FIG. 15.

(Step S34) The control section. 110 performs a second scanner reading process. The second scanner reading process will be described later by the use of FIG. 16.

(Step S35) The control section 110 transmits image data reading information to the lodging management server 300. The image data reading information includes image data acquired by photographing the passport and text data acquired by performing character recognition on the OCR region of the passport. The lodging management server 300 stores the image data reading information received from the control section 110 in a storage unit such as the HDD 313.

(Step S36) The control section 110 displays a reservation information confirmation screen on the display 120a. The reservation information confirmation screen displays reservation information received from the lodging management server 300. The control section 110 displays as the reservation information confirmation screen reservation information (lodging period, a room number, a room type, hotel charges, and the like) corresponding to the: reservation number.

(Step S37) The control section 110 displays a payment screen on the display 120a. A payment method is selected on the payment screen. The payment method is cash, a credit card, two-dimensional bar code payment using an application in a smartphone, virtual currency, a prepaid card, or the like. The control section 110 displays on the display 120a buttons on which a payment method is displayed. The customer selects a payment method displayed on a button by pressing down the button via the customer operation section 120.

If the customer pays hotel charges in advance and there is no need to pay hotel charges by the use of the automatic payment machine 100, then the control section 110 may omit step S37 and step S38.

(Step S38) The control section 110 performs a payment process by the payment method selected in step 337. For example, if a “Cash” button is pressed down via the touch panel 120b, then the control section 110 displays a cash acceptance screen on the display 120a and accepts cash via the banknote processing unit 160a and the coin processing unit 170a.

Furthermore, if a “Credit Card” button is pressed down via the touch panel 120b, then the control section 110 displays on the display 120a screen which explains credit card acceptance operation and accepts a credit card via the card/receipt processing unit 130a. The control section 110 transmits information regarding the accepted credit card to the payment server 500 to perform a credit card payment process.

(Step S39) The control section 110 prints the amount of money paid, the reservation information, and the like on a receipt via the card/receipt processing unit 130a, ejects the receipt from the card/receipt section 130, and issues the receipt.

If a credit card is selected as a payment method and the control section 110 accepts a credit card, then the control section 110 ejects the credit card via the card/receipt processing unit 130a to return the credit card to the customer.

(Step S40) The control section 110 displays a key issuance screen on the display 120a and issues a room key via the room key processing unit 140a. On the basis of the reservation information received from the lodging management server 300, the control section 110 performs setting to make a key card available for a lodging period (dates of the check-in and check-out) of the customer and the number of a room at which the customer lodges.

(Step S41) The control section 110 displays an end screen on the display 120a and ends the process.

As has been described, the automatic payment machine 100 gives the customer passport reading instructions regardless of whether the passport is an IC passport or not.

The first scanner reading process in the second embodiment will now be described by the use of FIG. 15. FIG. 15 illustrates an example of a flow chart illustrative of the first scanner reading process in the second embodiment.

In the first scanner reading process, the scanner processing unit 180a photographs an object (smartphone on which a bar code is displayed, a reservation slip on which a bar code is printed, the passport, or the like) laid on the scanner section 180 and performs reading. The first scanner reading process is performed by the control section 110 (processor 111) of the automatic payment machine 100 in step S17 and step S33 of the process by the automatic payment machine.

In the flow chart, description will be given by the use of the passport reading area 700. However, the first scanner reading process may be performed by the use of the passport reading area 700a or 700b or a plurality of passport reading areas 700, 700a, or 700b.

(Step S51) The control section 110 gives the scanner processing unit 180a instructions to photograph the object, and acquires image data.

(Step S52) The control section 110 determines whether or not an OCR region included in a page of the passport to be read is detected in the image data. If the OCR region of the passport is detected, then the control section 110 proceeds to step S56. If the OCR region of the passport is not detected, then the control section 110 proceeds to step S53.

(Step S53) The control section 110 determines whether or not a bar code (including a two-dimensional bar code) is detected in the image data. If the bar code is detected, then the control section 110 proceeds to step S54. If the bar code is not detected, then the control section 110 proceeds to step S51.

(Step S54) The control section 110 reads the bar code and acquires the reservation number.

(Step S55) The: control section 110 informs that reading the bar code is completed. For example, the control section 110 may indicate on the display 120a that reading the bar code is completed. Furthermore, the control section 110 may indicate by a speech output that reading the bar code is completed. In addition, the control section 110 may inform by making an LED light located near the scanner section 180 emit light that reading the bar code is completed.

(Step S56) The control section 110 determines whether or not a position in which the. OCR region is detected is included in an OCR reading subarea. (first OCR reading subarea 701 or the second OCR reading subarea. 702). If the OCR region is detected in the OCR reading subarea, then the control section 110 proceeds to step S57. If the OCR region is not detected in the OCR reading subarea, then the control section 110 proceeds to step S51.

(Step S57) The control section 110 performs character recognition on the OCR region detected in the image data and acquires character information (which consists of two lines of 44 characters each).

(Step S58) The control section 110 informs that reading the passport is completed. For example, the control section 110 may indicate on the display 120a that reading the passport is completed. Furthermore, the control section 110 may indicate by a speech output that reading the passport is completed. In addition, the control section 110 may inform by asking the LED light located near the scanner section 180 emit light that reading the passport is completed.

The second scanner reading process in the second embodiment will now be described by the use of FIG. 16. FIG. 16 illustrates an example of a flow chart illustrative of the second scanner reading process in the second embodiment.

In the second scanner reading process, the scanner processing unit 180a photographs the object laid on the scanner section 180 and performs reading. The second scanner reading process is performed by the control section 110 (processor 111) of the automatic payment machine 100 in step S18 and step S34 of the process by the automatic payment machine.

The second scanner reading process differs from the first scanner reading process in that the scanner processing unit 180a detects the passport by the use of a four-corner sensor (step S65). The other steps (steps S61 through S65 and steps S67 and S68) are the same as the: corresponding steps (steps S51 through S55 and steps S57 and S58) in the first scanner reading process. Accordingly, description of them will be omitted.

In the flow chart, description will be given by the use of the passport reading area 700. However, the second scanner reading process may be performed by the use of the passport reading area 700a or 700b or a plurality of passport reading areas 700, 700a, or 700b.

(Step S61) through (Step 565) performed by the control section 110 are the same as step S51 through step S55 respectively. Accordingly, description of them will be omitted.

(Step S66) The control section 110 determines whether or not the passport laid is in a stationary state. If the size of the reading window 811 of the scanner section 180 is equal (or approximately equal) to that of the passport, then the control section 110 determines, at the time when the control section 110 detects that all the outputs of the four-corner sensor (first sensor 801, the second sensor 802, the third sensor 803, and the fourth sensor 804) are “on,” that the passport is in a stationary state, and proceeds to step S67. If the control section 110 detects that all the outputs of the four-corner sensor are not “on,” then the control section 110 proceeds to step S61.

Furthermore, if the size of the reading window 811 of the scanner section 180 is larger (A4, for example) than that of the passport, which is a reading target medium, and the control section 110 detects that one or more outputs of the four-corner sensor are “on” for a certain period of time (for example, the fourth sensor 804 outputs “on” for five seconds), then the control section 110 determines that the passport is in a stationary state, and proceeds to step S67. If the control section 110 does not detect that any output of the four-corner sensor is “on” for a certain period of time, then the control section 110 proceeds to step S61.

The determination performed in this step by the use of the four-corner sensor may be performed at another timing.

(Step S67) and (Step S68) performed by the control section 110 are the same as step S57 and step S58 respectively. Accordingly, description of them will be omitted.

The automatic payment machine 100 detects in this way the OCR region included in a reading target page on the basis of the passport reading area 700, 700a, or 700b. Accordingly, even if a passport is laid upside down or in a laterally inverted state, the automatic payment machine 100 recognizes characters included in the OCR region.

When a customer uses a lodging facility, the automatic payment machine 100 acquires in this way information to be acquired from a passport regardless of whether the passport is an IC passport or not.

The automatic payment machine 100 improves a passport reading function in this way.

The above processing functions are realized with a computer. In that case, a program in which the contents of the function that the automatic payment machine 10 or 100, the customer terminal 200, the lodging management server 300, the front desk terminal 400, or the payment server 500 has are described is provided. The above processing functions are realized on the computer by executing the program by the computer. The program in which the contents of the function are described is recorded in a computer-readable record medium. The computer-readable record medium is magnetic storage, an optical disc, an optical magnetic record medium, a semiconductor memory, or the like. Magnetic storage is a hard disk drive (HDD), a flexible disk (FD), a magnetic tape, or the like. An optical disc is a DVD, a DVD-RAM, a compact disc read only memory (CD-ROM)/rewritable (RW), or the like. An optical magnetic record medium is an MO or the like.

For example, a portable record medium, such as a DVD or a CD-ROM, on which the program is recorded is sold in order to circulate the program. Furthermore, the program is stored in advance in a storage unit of a server computer and is transferred via a network from the server computer to another computer.

For example, a computer which executes the program stores in its storage unit the program recorded on a portable record medium or transferred from the server computer. The computer reads the program from its storage unit and performs a process in accordance with the program. The computer may read the program directly from the portable record medium and perform a process in accordance with the program. In addition, each time the program is transferred from the server computer connected via the network, the computer may perform a process in accordance with the received program.

Furthermore, at least part of the above processing functions may be realized by an electronic circuit such as a DSP, an ASIC, or a PLD.

According to an aspect, a passport reading function is improved.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that various changes, substitutions, and alterations could be made hereto without departing from the spirit and scope of the disclosure.

What is claimed is:

1. An automatic payment machine comprising:
a passport information reader configured to read passport information stored in a memory included in a passport;
an image reader configured to acquire image data, configured to perform a character recognition on the image data, and configured to read character information;
a display panel configured to display a screen and configured to accept an input;
a key issuing interface configured to issue a room key; and
a processor configured to give the passport information reader instructions to read the passport information and configured to perform a process including:
first verifying, upon acquiring the passport information via the passport information reader, reservation information and giving the key issuing interface, based on a result of the first verification, instructions to issue the room key; and
giving, upon failing to acquire the passport information via the passport information reader, the display panel instructions to display a designation screen for performing an operation to acquire the image data of the passport, acquiring the image data of the passport, giving the image reader instructions to perform the character recognition on the image data and read the character information, second verifying the reservation information after reading the character information, and giving the key issuing interface, based on a result of the second verification, instructions to issue the room key

2. The automatic payment machine according to claim 1, wherein:
the image reader is provided with a bar code reading function;
the first verifying includes verifying the reservation information, based on the passport information, a reservation number which the display panel is configured to accept as the input, or a reservation number read from a bar code read by the image reader; and
the second verifying includes verifying the reservation information, based on the character information, the reservation number which the display panel is configured to accept as the input, the reservation number read from the bar code read by the image reader, or an input which the image reader is configured to accept.

3. The automatic payment machine according to claim 1, wherein the process further includes transmitting to an information processing apparatus, based on information including at least one of a passport number, a nationality, a name, and a date of birth included in the passport information or the character information, a request to verify the reservation information.

4. The automatic payment machine according to claim 1, wherein the process further includes performing an expense payment process, based on the reservation information.

5. The automatic payment machine according to claim 1, wherein the image reader is configured to:
set a passport reading area for reading a page including a photograph, which is a reading target page, of pages included in the passport;
set a first character information reading subarea, which is a first subarea for reading the character information included in the reading target page, approximately parallel to a top of the passport reading area as an approximately rectangular subarea;
set a second character information reading subarea, which is a second subarea for reading the character information included in the reading target page, approximately parallel to a bottom of the passport reading area as an approximately rectangular subarea;
acquire an image within the passport reading area as the image data of the passport; and
perform the character recognition on images within the first character information reading subarea and the second character information reading subarea.

6. The automatic payment machine according to claim. 5, wherein the image reader includes a passport reading surface and is configured to set another passport reading area by turning around the passport reading area by 90 degrees with respect to the passport reading surface.

7. The automatic payment machine according to claim 5, wherein the image reader includes a passport reading surface and is configured to set a plurality of passport reading areas on the passport reading surface.

8. The automatic payment machine according to claim 7 wherein the image reader is configured to set the plurality of passport reading areas continuously or distributedly on the passport reading surface or so that the plurality of passport reading areas overlap on the passport reading surface.

9. The automatic payment machine according to claim 1, wherein the image reader includes a sensor configured to detect that the passport has become stationary.

10. The automatic payment machine according to claim 9, wherein the sensor includes an optical sensor configured to detect four corners of a reading target medium.

11. An automatic payment machine control method for an automatic payment machine, wherein:
the automatic payment machine includes a passport information reader, an image reader, a display panel, a key issuing interface, and a processor; and
the automatic payment machine control method includes:
giving, by the processor, the passport information reader instructions to read passport information stored in a memory included in a passport;
first verifying, by the processor, upon acquiring the passport information via the passport information reader, reservation information and giving the key issuing interface, on a basis of a result of the first verification, instructions to issue a room key; and
giving, by the processor, upon failing to acquire the passport information via the passport information reader, the display panel instructions to display a designation screen for performing an operation to acquire image data of the passport, acquiring the image data of the passport, giving the image reader instructions to perform a character recognition on the image data and read character information, second verifying the reservation information after reading the character information, and giving the key issuing interface, on a basis of a result of the second verification, instructions to issue the room key.
